(19) United States
(12) Patent Application Publication
(10) Pub. No.: US 2026/0357590 A1
(43) Pub. Date: Nov. 12, 2026

(54) SYSTEMS AND METHODS FOR ADDITIVE MANUFACTURING OF DISCONTINUOUSLY SUPPORTED STRUCTURES

(71) Applicant: THE PENN STATE RESEARCH FOUNDATION, University Park, PA (US)

(72) Inventors: Nate WATSON, University Park, PA (US); Sven BILÉN, University Park, PA (US); José Manuel PINTO DUARTE, University Park, PA (US); Shadi NAZARIAN, University Park, PA (US); Nicholas MEISEL, University Park, PA (US); Aleksandra RADLINSKA, University Park, PA (US)

(21) Appl. No.: 19/099,014

(22) PCT Filed: Jul. 27, 2023
(86) PCT No.: PCT/US2023/071156

§ 371 Date: Jan. 27, 2025

Related U.S. Application Data
(60) Provisional application No. 63/392,743, filed on Jul. 27, 2022.

(51) Int. Cl. E04G 21/02; B33Y 10/00

(52) U.S. Cl. CPC E04G 21/02; B33Y 10/00

(57) ABSTRACT

A method of manufacturing a structure is provided. The method includes securing a reinforcing structure to a base structure using an automated extruder. The base structure defines a first support portion and a second support portion, and the reinforcing structure is secured to each of the first support portion and the second support portion to define an unsupported area between the first support portion and the second support portion. The method further includes, extruding a first layer of a matrix material onto the unsupported area of the reinforcing structure using the automated extruder.

### CROSS-REFERENCES TO RELATED APPLICATIONS

This application claims the benefit of U.S. Provisional Patent Application No. 63/392,743 filed Jul. 27, 2022, the disclosure of which is hereby incorporated by reference in its entirety for all purposes.

### STATEMENT REGARDING FEDERALLY SPONSORED RESEARCH

Not applicable.

### TECHNICAL FIELD

This disclosure is directed to systems and methods for additive manufacturing of infrastructure (i.e., additive construction). More specifically, such systems and methods are directed at additive manufacturing techniques for producing discontinuously supported structures (e.g., structures that are not continuously supported), such as raised slabs, overhangs, mezzanines, balconies, canopies, and other elevated structures, using automated systems, which can be applied in a variety of environments, including for both terrestrial and extraterrestrial construction.

### BACKGROUND

Concrete is commonly used as a building material for a wide variety of applications and in a wide variety of environments. However, traditional techniques for building infrastructure with concrete are very labor-intensive, requiring that workers assemble formwork (e.g., a hollow, external structure forming a negative shape of the final structure) into which wet concrete is poured and then cured to take on the desired, final shape. Because the formwork must provide a negative shape of the final structure, use of formwork can limit the types and shapes of structures that can be produced. Furthermore, the use of formwork in traditional construction also adds significant cost, accounting for anywhere between 35% and 65% of the total cost of construction. Correspondingly, formwork makes customization more expensive.

One way to alleviate some of the shortcomings associated with traditional concrete construction using formwork is to use additive manufacturing, which three-dimensionally prints a structure layer by layer, without the need for traditional formwork. For example, concrete can be printed (e.g., deposited via extrusion by an automated extruder) onto a continuous base structure or existing deposited concrete material to gradually build the desired structure. As a result, the structure can be made without having to assemble formwork, leading to reduced production time, cost, and labor requirements, while also giving the ability to produce highly-complex and highly-customizable structures that would not otherwise be feasible or possible with traditional construction methods.

These benefits are particularly useful in extraterrestrial construction applications, which can pose hazards far too dangerous for humans to be on site for extended periods of time, or to be on site at all. Further, use of additive construction techniques allows for material to be used in situ, thus, drastically reducing the amount on material that must be transported from earth.

However, as mentioned above, such known additive construction techniques generally require that each subsequent layer be deposited on a base structure or previously deposited layer, which provide continuous and direct support to the subsequent layer along its entire length. This is particularly important given the highly-viscous, yet liquid nature of concrete prior to curing. Consequently, these known additive construction techniques are incapable of building discontinuously supported structures, including, for example, raised slabs and overhangs, which must then be added using other processes and techniques (e.g., by securing a pre-formed component to a base structure created using additive construction techniques).

In light of at least the above, there exists a need for additive construction techniques that can directly produce discontinuously supported structures. Furthermore, it is desirable that such additive construction techniques can be partially or fully automated to minimize the need for manual labor or intervention. The discussion above is merely provided for general background information and is not intended to unduly limit the scope of the claimed subject matter.

### SUMMARY

The above problems can be solved by systems and methods for manufacturing a discontinuously supported structure using an automated extruder (e.g., an extrusion system that is controlled by an electronic controller).

According to one aspect of the disclosure, a method of manufacturing a structure (e.g., a discontinuously supported structure) is provided. The method can include securing a reinforcing structure to a base structure using an automated extruder. The base structure can define a first support portion and a second support portion and the reinforcing structure can be secured to each of the first support portion and the second support portion to define an unsupported area between the first support portion and the second support portion. Additionally, the method can further include extruding a first layer of a matrix material onto the unsupported area of the reinforcing structure using the automated extruder. The first layer can substantially cover the reinforcing structure (e.g., to be substantially coextensive with the reinforcing structure). In some cases, the method can further include allowing the matrix material to solidify to form a slab that is supported along a first edge by the first support portion and along a second edge by the second support portion, and that is unsupported between the first support portion and the second support portion.

In some non-limiting examples, the method can further include extruding a second layer of the matrix material onto the first layer so that the second layer substantially covers (e.g., is substantially coextensive with) the first layer. The first layer can be formed by extruding a first series of parallel beads at a first angle and the second layer can be formed by extruding a second series of parallel beads at a second angle. In some cases, the first angle can be orthogonal to the second angle.

In some non-limiting examples, the reinforcing structure is a mesh formed from one more elongate strands, which can be sections of a single continuous strand. The mesh can define a gap distance that is less than a bridging limit of the matrix material.

In some cases, securing the reinforcing structure to the base structure can include coupling a first plurality of anchors to the first support portion of the base structure and a second plurality of anchors to the second support portion of the base structure. The one or more elongate strands can be secured to extend between at least one of the first plurality of anchors and at least one of the second plurality of anchors, and may further be secured at a predetermined tension.

In some cases, securing the reinforcing structure to the base structure can include coupling a first brace to the first support portion of the base structure and coupling a second brace to the second support portion the base structure. The first brace including a stationary member that is fixedly secured to the base structure and a movable member configured to move relative to the stationary member. The one or more elongate strands can be secured to extend between the movable member of the first brace and the second brace. The movable member can be moved relative to the stationary member to apply a tension to the one or more elongate strands.

In some non-limiting examples, the matrix material can be a cementitious material. Also, in some non-limiting examples, the base structure can be formed by extruding the matrix material using the automated extruder.

According to another aspect of the disclosure, a method of manufacturing a structure is provided (e.g., a discontinuously supported structure). The method can include securing a reinforcing structure to a base structure using an automated extruder. The reinforcing structure can be secured to and supported by the base structure at least partially along a perimeter of the reinforcing structure and can be unsupported within a central area of the reinforcing structure. The method can also include extruding a matrix material onto the central area of the reinforcing structure, using the automated extruder. In some cases, the matrix material may substantially cover the reinforcing structure. In some cases, the method can further include allowing the matrix material to solidify to form a slab with the reinforcing structure, wherein the slab is secured to and supported by the base structure along a perimeter of the slab and is unsupported at the central area of the slab.

This Summary and the Abstract are provided to introduce a selection of concepts in a simplified form that are further described below in the Detailed Description. This Summary is not intended to identify key features or essential features of the claimed subject matter.

### DRAWINGS

The following detailed description is to be read with reference to the figures, in which like elements in different figures have like reference numerals. The figures, which are not necessarily to scale, depict selected embodiments and are not intended to limit the scope of embodiments of the disclosure. Given the benefit of this disclosure, skilled artisans will recognize the examples provided herein have many useful alternatives that fall within the scope of the disclosure.

FIG. 1 is a top view of a discontinuously supported structure, according to aspects of the disclosure.

FIG. 2 is a cross-sectional view of the discontinuously supported structure of FIG. 1, taken along line II-II shown in FIG. 1.

FIG. 3 is a flowchart of a method of manufacturing a discontinuously supported structure having an unsupported area, according to aspects of the disclosure.

FIG. 4 is an isometric view of a reinforcing structure secured to a base structure, according to aspects of this disclosure.

FIG. 5 is a top plan view of a reinforcing structure secured to a base structure with a plurality of anchors, according to aspects of this disclosure.

FIG. 6 is a simplified cross-sectional view of the reinforcing structure and the base structure of FIG. 5, taken along line VI-VI shown in FIG. 5.

FIG. 7 is a perspective view of a reinforcing structure secured to a base structure with a brace system, according to aspects of this disclosure.

FIG. 8 is a perspective view of an automated extruder extruding a matrix material onto a reinforcement structure, according to aspects of this disclosure.

FIG. 9 is a schematic view of a bead of a matrix material being supported on a reinforcing structure, according to aspects of this disclosure.

FIG. 10 is a schematic view of a bead of a matrix material being extruded onto a reinforcing structure, according to aspects of this disclosure.

FIG. 11 is a schematic view of a bead of a matrix material being extruded onto a reinforcing structure, according to aspects of this disclosure.

FIG. 12 is a plot of Brigham curves for an example matrix material obtained from experimental data.

FIG. 13 is a plot of shear stress curves for the example matrix material of FIG. 12.

FIG. 14 is a plot of static yield stress over time for the example matrix material of FIG. 12.

FIG. 15 is plot of plastic viscosity versus RMP for the example matrix material of FIG. 12.

FIG. 16 is a plot of plastic viscosity over time for the example matrix material of FIG. 12.

FIG. 17 is a plot showing the flowability of the example matrix material of FIG. 12 with different resting times.

FIG. 18 is a plot showing the buildability (e.g., residual height) of the example matrix material of FIG. 12 with different resting times.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having,” and variations thereof, herein is meant to encompass the items listed thereafter and equivalents thereof as well as additional items. Unless specified or limited otherwise, the terms “mounted,” “connected,” “supported,” and “coupled,” and variations thereof, are used broadly and encompass both direct and indirect mountings, connections, supports, and couplings. Likewise, “connected” and “coupled” are not restricted to physical or mechanical connections or couplings unless identified as such. Furthermore, throughout the description, terms such as front, back, side, top, bottom, up, down, upper, lower, inner, outer, above, below, and the like are used to describe the relative arrangement and/or operation of various components of the example embodiment; none of these relative terms are to be construed as limiting the construction or alternative arrangements that are within the scope of the claims.

Additionally, as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Further, unless otherwise specified or limited, the terms “about” and “approximately” as used herein with respect to a reference value refer to variations from the reference value of +5%, inclusive. Similarly, the term “substantially” as used herein with respect to a reference value refers to variations from the reference value of less than +30%, inclusive. Unless otherwise noted, ranges as listed herein are inclusive of endpoints of the range.

The following discussion is presented to enable a person skilled in the art to make and use embodiments of the disclosure. Given the benefit of this disclosure, various modifications to the illustrated embodiments will be readily apparent to those skilled in the art, and the principles herein can be applied to other embodiments and applications without departing from embodiments of the disclosure. Thus, embodiments of the disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

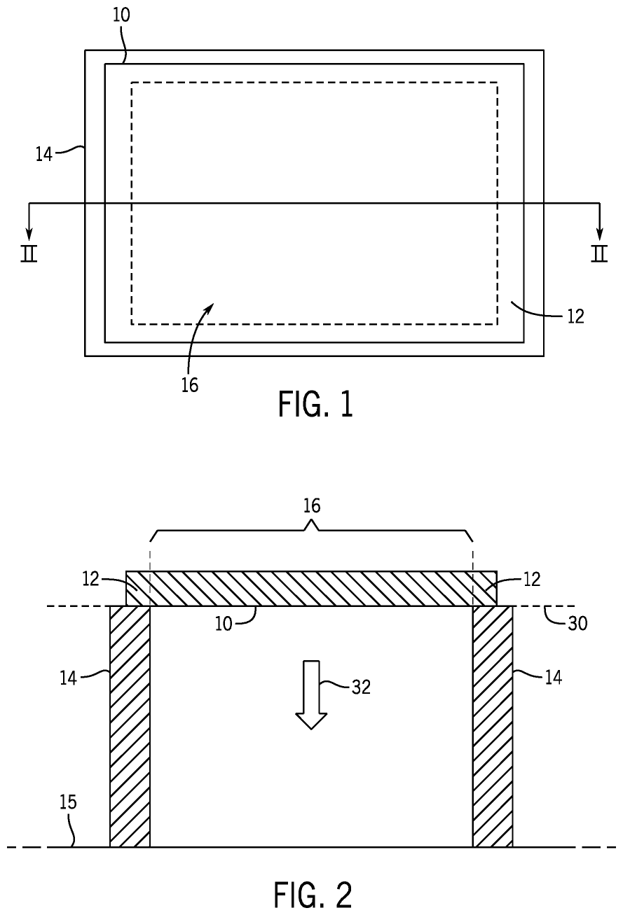

As noted above, a need exists for a method for additive manufacturing (i.e., constructing) of discontinuously supported structures, in particular, cementitious architectural structures, without the need for continuous external formwork required by conventional construction and additive manufacturing techniques. For the purpose of this discussion, and referring to FIGS. 1 and 2, such discontinuously supported structures 10 (e.g., a slab) include structures that are directly supported along their periphery 12 (e.g., along a peripheral edge), or a portion thereof, by a base structure 14, and which include an unsupported area 16 (e.g., a central area or span) that is not directly supported by the base structure 14 or another structure engaged with a foundation surface 15. Some non-limiting examples of unsupported structures include raised slabs, such as those used in roofs, mezzanines, ceilings, balconies, canopies, overhangs, etc.

Such methods for additive manufacturing of unsupported structures can be particularly useful in constructing (e.g., by three-dimensional printing/extruding) slabs and other discontinuously supported structures that are angled to be below a self-supporting angle of the matrix material being used. The self-supporting angle of a matrix material is the angle at which the extruded matrix material can extend (e.g., an angle of the final structure formed by the matrix material), relative to a horizontal plane 30 (e.g., a plane that is perpendicular to a gravitational force 32). Generally, with conventional additive manufacturing systems, a matrix material cannot be printed at angles that are less than the self-supporting angle of the matrix material (e.g., between approximately 50 degrees and approximately 70 degrees for cementitious materials, depending on material composition and viscosity) without the use of (temporary) external supports that are configured to counter the terrestrial gravitational forces acting on the matrix material. As such, traditional additive manufacturing systems are generally incapable of building structures below the self-supporting angle of the matrix material without using external supports or formwork, each of which increases cost, complexity, and manufacturing times.

Relatedly, and in particular with cementitious materials, matrix materials used in three-dimensional printing can be significantly weaker in tension than they are in compression; even more so when in a flowable state, such as that during pouring or extrusion. Accordingly, to improve the tensile strength of a matrix material, reinforcing structures, for example, wire mesh or rebar, can be embedded within the matrix material in its flowable form, after which the matrix material solidifies as it cures. The reinforcing structure thereby provides internal support to the finished structure (e.g., a concrete slab), improving strength in tension. Generally, with conventional methods, to embed the reinforcing structure in the matrix material, the reinforcing structure is placed within a cavity (e.g., a cavity bounded by formwork or another continuous surface, such as the ground) and the matrix material is poured into the cavity to surround the reinforcing structure. The liquid matrix material is then supported by the walls of the cavity until it solidifies. In some cases, to further improve tensile strength of a discontinuously supported structure, traditional rebar structures can also be embedded within a matrix material.

Aspects of the present disclosure provide advantages over such conventional systems and techniques by allowing a matrix material to be extruded to form discontinuously supported structures (e.g., slabs) at or below the self-supporting angle of the matrix material, without the need for external or continuous support structures. More specifically, methods of manufacturing a discontinuously supported structure according to the present disclosure utilize a reinforcing structure to support a matrix material that is in a flowable state. For example, a reinforcing structure can be secured to a base structure along at least a portion of a periphery (e.g., a peripheral, supported area) of the reinforcing structure so that the reinforcing structure defines an unsupported area that is not directly supported by the base structure or another structure engaged with a foundation. A flowable matrix material can then be extruded to be substantially coextensive with the reinforcing structure. That is, the matrix material can be extruded (e.g., to form a plurality of parallel beads of the matrix material) into a first layer that substantially covers an entire area of the reinforcing structure (e.g., to substantially cover and extend throughout both the supported area and the unsupported area). Subsequent layers of the matrix material can then be extruded on top of the first layer. Thus, the reinforcing structure supports the matrix material during printing and may also be at least partially embedded into the matrix material. Consequently, the reinforcing structure may be incorporated (e.g., embedded) into the matrix material to reinforce the final structure (e.g., a slab) once the matrix material solidifies (e.g., cures or otherwise hardens into a solid state), increasing strength of the final structure in tension.

Additionally, such methods for additive manufacturing of discontinuously supported structures according to this disclosure can be performed using one or more automated extruders (i.e., automated extrusion systems) that are configured to (continuously) extrude a bead of a matrix material in one or more layers to three-dimensionally print an unsupported structure. Automated extruders can include, for example, gantry systems, cable-driven systems, robotic arm systems, and swarm printing systems (e.g., cooperative printing systems using multiple extruders to print a single structure). Moreover, in some cases, and as discussed in greater detail below, an automated extruder (e.g., a 6-axis robotic arm) can be configured to manufacture a discontinuously supported structure without the need for human intervention, including placing reinforcing structures, anchoring systems for such reinforcing structures, and extruding a matrix material. Correspondingly, an automated extruder can be configured to operate one or more implements or tools that allow the automated extruder to perform one or more desired tasks. For example, an automated extruder can include an extruding head for extruding a matrix material and a gripping or other multipurpose head/end effector for manipulating objects, such as for securing a reinforcing structure to a base structure. In some non-limiting examples, an extruder can include multiple heads that can be swapped out to perform a particular task. In other non-limiting examples, specialty, purpose-built machines, or robots can be configured to perform all or a subset of tasks of an automated extrusion system. The extruder head may also include a tensioning device or function to tension the cables. This function of tensioning the cables can be done by the same robot that extruding the material or by another robot.

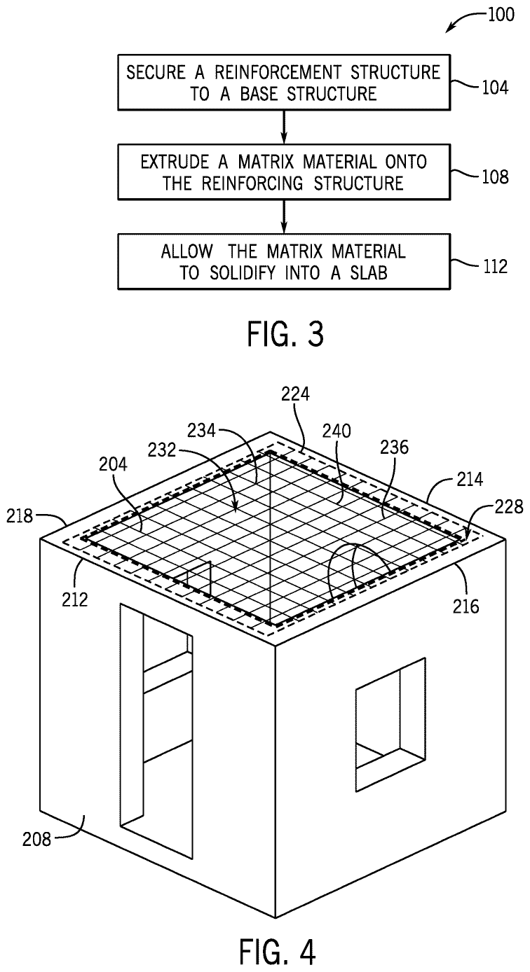

Turning now to FIG. 3, a method 100 of manufacturing a discontinuously supported structure (e.g., a structure having at least a portion that is not directly supported) is illustrated according to aspects of this disclosure. The method 100 can be used to manufacture a variety of structures (e.g., the slab 10), including both planar and non-planar structures, which can be parallel with a horizontal plane (e.g., the horizontal plane 30) or at a non-zero angle relative to the horizontal plane. More specifically, the method 100 is particularly useful in manufacturing structures that are angled between 0 degrees and a non-supporting angle of a matrix material being extruded (e.g., by an automated extruder) to form the discontinuously supported structure.

At block 104, the method 100 can include securing a reinforcing structure to a base structure (e.g., a structure formed by additive manufacturing or other construction techniques). More specifically, a reinforcing structure can be secured between two or more support portions of a base structure so that the reinforcing structure is directly supported along the support portions of the base structure (e.g., along a peripheral edge of the reinforcing structure) and has an unsupported region extending between the respective support portions of the base structure. The support portions of the base structure can be coupled together or can be separate portions that are spaced from one another.

For example, with additional reference to FIG. 4, a reinforcing structure 204 is illustrated being secured to a base structure 208. The base structure 208 has a substantially square perimeter with a first support portion 212 opposite a second support portion 214, and a third support portion 216 opposite a fourth support portion 218, each extending between the first support portion 212 and the second support portion 214. The reinforcing structure 204 defines a substantially square outer perimeter 224 and is secured to the base structure 208 along a peripheral area 228 that is proximate the outer perimeter 224. The peripheral area 228 of the reinforcing structure 204 is coupled to and directly supported by the base structure 208 at each of the first, second, third, and fourth support portions 212-218 of the base structure 208. Correspondingly, the reinforcing structure 204 further defines an unsupported area 232 inward of the peripheral area 228, which is not directly supported by the base structure 208. That is, in the non-limiting example of FIG. 4, the unsupported area 232 has a generally square shaped area that extends between each of the first, second, third, and fourth support portions 212-218 of the base structure 208. In other non-limiting examples, the base structures and reinforcing structures can have other shapes, for example, any polygonal or non-polygonal shape.

Relatedly, and as mentioned above, a reinforcing structure can be configured as a mesh-like structure comprised of one or more elongate strands (e.g., wires, cables, rebar, pipes, strands, ropes, etc.), which can have a variety of cross-sectional shapes as required by a specific application. For example, still referring to FIG. 4, the reinforcing structure 204 is a mesh formed from an elongate strand 234 including a first plurality of elongate strands 236 extending between the first support portion 212 and the second support portion 214 of the base structure 208, and a second plurality of elongate strands 240 extending between the third support portion 216 and the fourth support portion 218 of the base structure 208. In other non-limiting examples, elongate strands can be oriented differently, for example, to extend between any two support portions of a base structure (e.g., between the first support portion 212 and any of the second, third, and fourth support portions 214-218). Correspondingly, elongate strands can be arranged to form a variety of mesh patterns not expressly shown here, including both regular and irregular patterns. Additionally, elongate strands can be sections of a single continuous elongate strand, or they can be separate elongate strand portions. The elongate strands can be overlaid in layers or woven together on site, or the elongate strands can be arranged off-site as a pre-formed mesh that can be attached to a base structure.

In either case, multiple elongate strands can be secured to one another (e.g., where two elongate strands cross or intersect) to prevent relative movement therebetween and to increase rigidity of the reinforcing structure. Moreover, a pre-determined tension can be applied to the elongate strands to reduce a downward deflection of a reinforcing structure (e.g., to control a vertical displacement of reinforcing structure) once a matrix material is applied to the reinforcing structure, as described in greater detail below. The specific tension applied to the elongate strands can vary depending on the specific application, including for example, the material, number, and size of the elongate strands, and the mass of the matrix material or other load being supported. In some cases, the tension applied to the elongate strands can be selected to limit downward deflection to a maximum amount permitted by a building code or other rule or ordinance.

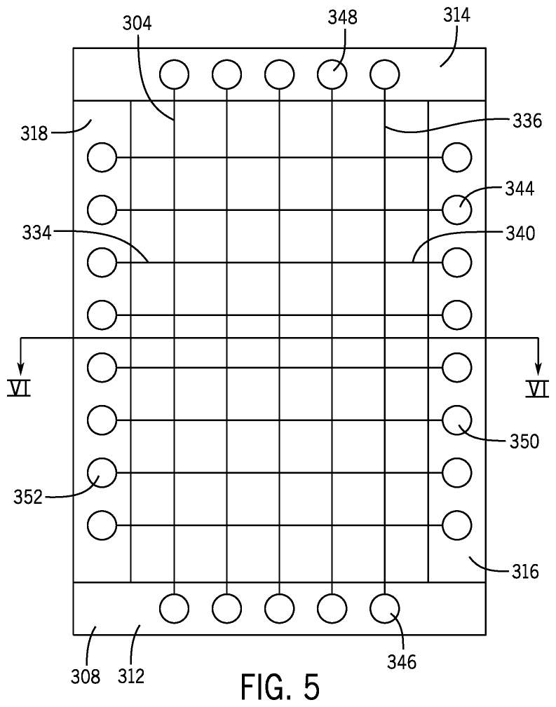

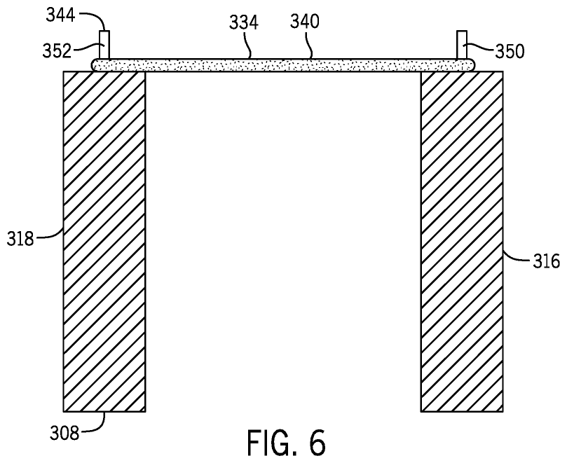

A reinforcement structure can be secured to a base structure in a variety of ways, including by using an automated extruder, or manually by a worker. For example, with additional reference to FIGS. 5 and 6, a reinforcing structure 304 can be secured to a base structure 308 with a plurality of anchors 344 (e.g., concrete anchors) that are embedded into the base structure 308. The anchors 344 are configured to couple to the reinforcing structure 304 (e.g., by tying, wrapping, or clamping) so as to couple the reinforcing structure 304 to the base structure 308. More specifically, as illustrated, the plurality of anchors 344 includes a first plurality of anchors 346 arranged along a first support portion 312 of the base structure 308, a second plurality of anchors 348 arranged along a second support portion 314 of the base structure 308, a third plurality of anchors 350 arranged along a third support portion 316 of the base structure 308, and a fourth plurality of anchors 352 arranged along a fourth support portion 318 of the base structure 308. Each of the first plurality of elongate strands 336 is connected to extend between one of the first plurality of anchors 346 and one of the second plurality of anchors 348, and each of the second plurality of elongate strands 340 is connected to extend between one of the third plurality of anchors 350 and one of the fourth plurality of anchors 352. In other non-limiting examples, for example, where one or both of the first plurality of elongate strands 336 or the second plurality of elongate strands 340 are configured as sections of a single continuous strand, the single continuous strand can extend between multiple anchors 344.

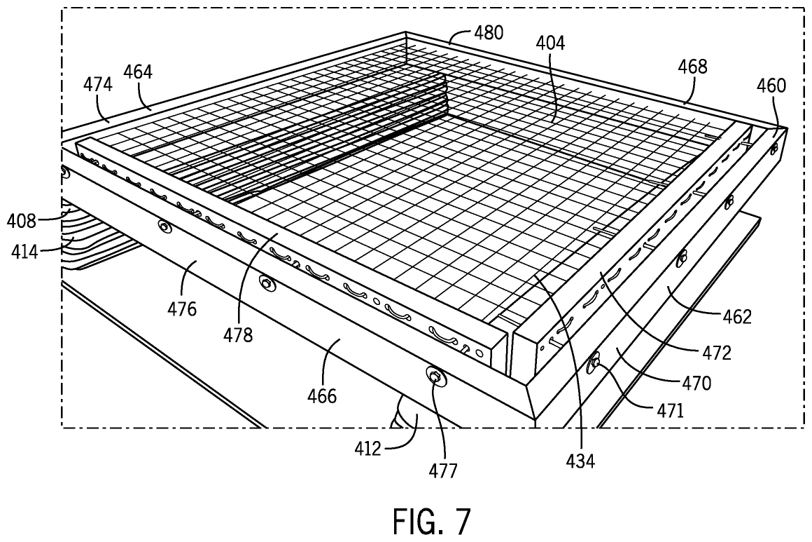

Referring now to FIG. 7, in some non-limiting examples, a reinforcing structure 404 can be secured to a base structure 408 with a brace system 460, which acts as an anchor for the reinforcing structure 404. In some non-limiting examples, the brace system 460 can be an intermediary support to support the reinforcing structure 404 on a base structure 408 and may also be configured to tension the reinforcing structure 404 (e.g., any elongate strands) to a desired operational tension. As illustrated, the brace system 460 can be coupled to the base structure 408 and includes a first brace 462 opposite a second brace 464, and a third brace 466 opposite a fourth brace 468. The first brace 462 is configured to couple to a first support portion 412 of the base structure 408 and the second brace 464 is configured to couple to a second support portion 414 of the base structure 408, which is spaced from the first support portion 412. As illustrated, the third brace 466 and the fourth brace 468 are coupled to and supported by each of the first brace 462 and the second brace 464; however, they can alternatively or additionally be supported by corresponding portions of the base structure 408, or they may not be included. A single, continuous elongate strand 434 extends between each of the braces 462-268 to form the mesh reinforcing structure 404 (e.g., so that multiple strand sections extend between the braces 462-268); however, separate elongate strands can also be used. In other non-limiting examples, more or fewer braces can be used depending on the specific configuration, which may depend on, for example, a shape of a base structure or a desired mesh pattern of a reinforcing member.

In some cases, the brace system 460 can be configured as an adjustable brace system that can be used to apply the predetermined tension to the elongate strand 434. For example, as illustrated in FIG. 7, the first brace 462 includes a first stationary member 470 that is fixedly secured to the first support portion 412 and a first movable member 472 that is coupled to and configured to move relative to the first stationary member 470, while the second brace 464 includes a second stationary member 474 that is fixedly secured to the second support portion 414 of the base structure 408. Similarly, the third brace 466 includes a third stationary member 476 fixedly secured between the first stationary member 470 and the second stationary member 474, and a second movable member 478 that is coupled to and configured to move relative to the third stationary member 476, while the fourth brace 468 includes a fourth stationary member 480 fixedly secured between the first stationary member 470 and the second stationary member 474. The elongate strand 434 is secured to each of the first movable member 472, the second stationary member 474, the second movable member 478, and the fourth stationary member 480 (e.g., by passing through holes in the respective members).

To apply a tension to the elongate strand 434, the first movable member 472 can be moved relative to the first and second stationary members 470, 474, and/or the second movable member 478 can be moved relative to the third and fourth stationary members 476, 480, to apply a desired tension to the elongate strand 434. For instance, tension rods 471 extend between and couple the first stationary member 470 and the first movable member 472, such that adjusting the tension rods 471 alters the distance between the first stationary member 470 and the first movable member 472, thus impacting the tension of the elongate strand 434. Similarly, tension rods 477 extend between and couple the third stationary member 476 and the second movable member 478, such that adjusting the tension rods 477 alters the distance between the third stationary member 476 and the second movable member 478, thus impacting the tension of the elongate strand 434.

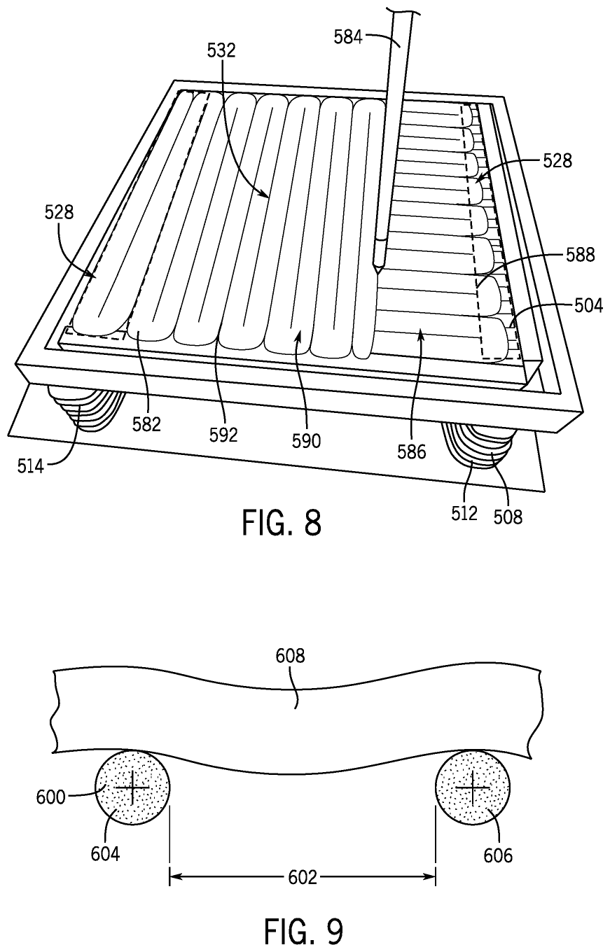

Continuing, at block 108, a matrix material (e.g., a cementitious matrix material) can be extruded onto a reinforcing member. For example, with additional reference to FIG. 8, a matrix material 582, in an extrudable (e.g., flowable) state can be extruded onto the reinforcing structure 504 using an automated extruder 584, which can, in some cases, be the same extruder used to secure the reinforcing structure 504 to a base structure 508 having a first support portion 512 and a second support portion 514. In general, the extruder 584 can be configured to automatically extrude the matrix material 582 (e.g., in accordance with commands from an electronic control system, not shown), to be substantially coextensive with the reinforcing structure 504. That is, the extruder 584 can extrude the matrix material 582 to substantially cover and extend throughout the reinforcing structure 504 (e.g., to substantially cover each of a peripheral area 528 and an unsupported area 532 of the reinforcing structure 504). In this way, the matrix material 582 is supported by the base structure 508 and the reinforcing structure 504 in the peripheral area 528 (e.g., at a brace system), and by the reinforcing structure 504 in the unsupported area 532.

In some cases, matrix material can be extruded into one or more layers to increase a thickness of the extruded material, and thus the final discontinuously supported structure (e.g., the slab 10). For example, still referring to FIG. 8, the extruder 584 is configured to extrude a first layer 586 of matrix material 582 onto the reinforcing structure 504. As illustrated, the first layer 586 is formed by extruding a first plurality of parallel beads 588 of matrix material 582 onto the reinforcing structure 504 at a first angle (e.g., to extend between the first support portion 512 and the second support portion 514, and between the first brace 562 and the second brace 564).

Due to the mesh structure of the reinforcing structure 504, the extruded matrix material 582 of the first layer 586 also covers the gaps formed by the elongate strand 534. For example, turning briefly to FIG. 9, a reinforcing structure 600 can include a gap 602 defining a gap distance that is formed between a first elongate strand 604 and a second elongate strand 606 (e.g., separate elongate strands or segments of a single elongate strand), and a bead 608 of matrix material bridges (i.e., spans) the gap 602 to be supported at each of the first elongate strand 604 and the second elongate strand 606.

However, due to the flowable nature of the matrix material, the bead 608 can deform and potentially break or fracture if the gap 602 is too large. Accordingly, the bead 608 defines a bridging limit, which is a maximum distance that the bead 608 can span without failure (e.g., breaking, fracturing, excessive drooping). Thus, if the gap 602 between the first elongate strand 604 and the second elongate strand 606 is greater than the bridging limit, the bead 608 can, for instance, collapse though the gap 602 or otherwise fail. Accordingly, to maintain structural integrity of a bead (e.g., to ensure the first layer 586 of matrix material 582 is supported by and substantially covers the reinforcing structure 504), it is preferrable that a gap of a reinforcing structure is less than a bridging limit of the bead. For example, given a particular application-specific bridging limit, a gap that is less than the bridging limit may be used to provide consistent results (e.g., the gap is less than 95% of the bridging limit, less than 80% of the bridging limit, or less than 50% of the bridging limit).

The bridging limit of a bead can vary depending on a number of factors and can be tuned to a specific application with specific application design restraints and requirements. For example, beads and elongate strands with larger diameters (e.g., cross-sectional areas) can generally provide for increased bridging limits. Similarly, elongate strands with larger surface areas can be used to provide for increased bridging limits, as the increased surface area can reduce the effects of the elongate strand from cutting into the deposited matrix. Additionally, a bridging limit of a bead can depend on the material composition of the bead and its viscosity, as well as the flow rate of the matrix material and the speed of the extruder (e.g., a speed relative to a reinforcing structure). Moreover, a deposition height (e.g., a distance between a nozzle of the extruder 284 and the reinforcing structure 204) can also affect the bridging limit. Specifically, the deposition height can be selected in accordance with a tensile strength of the flowable matrix material during extrusion to allow a bead of matrix material to be across a gap between elongate strands while the matrix material is hung from the nozzle. In that regard, if the deposition height is too high, the matrix material may not be able to support the length of the bead hanging from the nozzle, and if the deposition height is too low, the bead hanging off the nozzle may drop below the cables and be sliced off by the next cable.

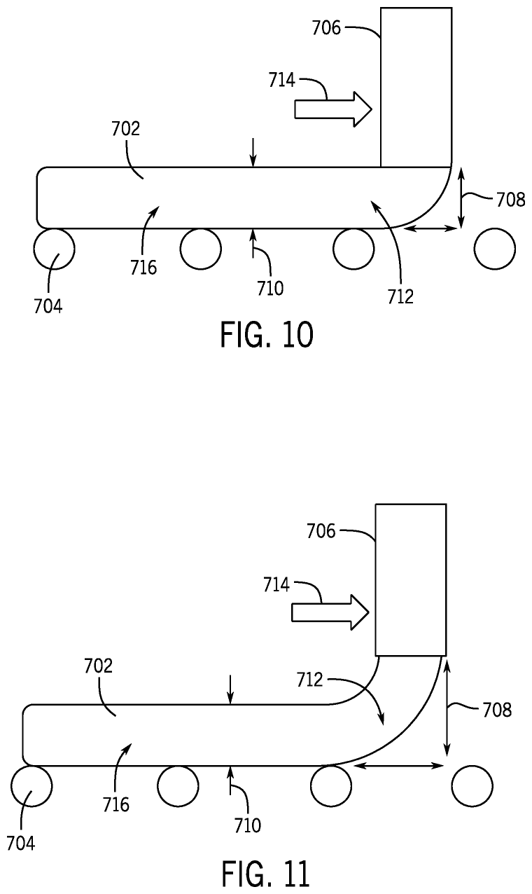

For example, referring now to FIGS. 10 and 11, while extruding a bead 702 of matrix material onto a reinforcing structure 704 from an extruder 706 at a deposition height 708 that is equal to a layer height 710 (e.g., a diameter of the bead 702 or a dimension of the bead 702 taken parallel with the deposition height 708, see FIG. 10) can produce a desirable result (e.g., a continuous bead with substantially uniform cross-section) on continuous surfaces, the bead 702 may be generally unable to span large gaps in the reinforcing structure 704 without breaking. However, by increasing the deposition height 708 to be greater than the layer height 710 (see FIG. 11), the bead 702 being extruded can span larger gaps. This is because the increased deposition height 708 allows for a longer portion of the bead 702 to remain elevated off of the reinforcing structure 704 by the tensile strength of the matrix material. This elevated portion 712 of the bead 702 is formed due to the forces acting on the bead 702 as the extruder 706 moves relative to reinforcing structure 704, as indicated by arrow 714, while continuously extruding matrix material to form the bead 702. More specifically, tension is produced in the bead 702 as a laid portion 716 of the bead 702 (e.g., the portion being supported by and in contact with the reinforcing structure 704) pulls back on the elevated portion 712 and the portion and the matrix material that is still within the extruder 706 pulls up on elevated portion 712. This causes the elevated portion 712 of the bead 702 to curve upwardly toward the extruder 706 and allows the elevated portion 712 of the bead 702 to span gaps in the reinforcing structure 704. For example, in a preferred non-limiting example, a ratio of a deposition height to a layer height can range anywhere between 1 and 5, and more preferably between 1 and 2, and even more preferably between 1.6 and 1.7. In addition, in one example, a 1 to 1 ratio of deposition height to layer height established a bridging limit that was about 133% of the deposition height, and a 5 to 3 ratio of deposition height to layer height established a bridging limit that was about 320% of the deposition height.

Correspondingly, in some non-limiting examples, an extruder can be configured to dynamically adjust the deposition height/offset relative to a reinforcing structure. For example, depending on a tension of an elongate strand, a reinforcing structure may experience sagging due to gravitational or other forces acting on the reinforcing structure. Accordingly, a reinforcing structure my not be planar. Yet, it is preferrable that the deposition height/offset remains substantially constant no matter the position of the extruder relative to the reinforcing structure. To account for this, an extruder can be configured to dynamically adjust its position (e.g., height) relative to the reinforcing structure to maintain an approximately constant deposition offset. Further, the deposition height/offset can also be adjusted depending on other factors, for example, in accordance with a measured viscosity of a matrix material, or whether the extruder is extruding onto an existing layer of matrix material (e.g., the deposition height/offset can be a highest value when extruding directly onto a reinforcing structure, and lower when extruding onto a first or another layer of previously extruded matrix material).

Turning back to FIG. 8, once the first layer 586 is formed, the extruder 584 can then extrude a second layer 590 onto the first layer 586 so that the first layer 586 is disposed between the reinforcing structure 504 and the second layer 590. The second layer 590 can be substantially coextensive with the first layer 586 to substantially cover the first layer 586. Correspondingly, the second layer 590 can be similarly formed by extruding a second plurality of parallel beads 592 of matrix material 582 onto the first layer 586 at a second angle (e.g., to extend between the third brace 566 and the fourth brace 568). Here, the first angle is orthogonal to the second angle, however this may not always be the case. In other non-limiting examples, additional layers can be extruded onto the second layer (e.g., a third layer can be deposited onto a second layer at a third angle, a fourth layer can be deposited onto the third layer at a fourth angle, etc.). It is appreciated that the various layers can be printed continuously, or non-continuously with pauses between layers or between portions of layers as required to maintain structural integrity during operations at block 108.

Continuing, at block 112, extruded matrix material can solidify to form a discontinuously supported structure (e.g., the slab 10) with a reinforcement structure. That is, at block 112, the matrix material 582 can cure or otherwise harden into a solid form. More specifically, the matrix material 582 can solidify so that the reinforcement structure 504 is secured to (e.g., at least partially embedded in) the solidified matrix material 582 to form a final discontinuously supported structure (e.g., the slab 10). Once solidified, the structure can be configured to support an external load, with the reinforcing structure 504 providing increased strength to the structure when under tension (e.g., with a vertical load being applied to the slab 10).

In some cases, for example, where at least half of a cross-sectional area of an elongate strand of a reinforcing structure is embedded into a matrix material, the solidified structure may exhibit composite behavior, in which there is a non-slip interface between the solidified matrix and the reinforcing structure. Under composite behavior, tensile loading on the structure is distributed through both the solidified matrix material and the reinforcing structure. In some cases, for example, where at least half of a cross-sectional area of an elongate strand of a reinforcing structure is not embedded into a matrix material, the solidified structure may exhibit non-composite behavior, in which there may be a slip interface between a reinforcement structure and the solidified matrix material. Under non-composite behavior a tensile load in the solidified matrix material may not be distributed through the reinforcing structure.

### EXPERIMENTAL RESULTS

As discussed above, the bridging limit of an extruded matrix material can depend on the material properties of the matrix material, as well as other operation parameters of an extrusion system (e.g., deposition height, deposition rate (e.g., volumetric flow rate), extrusion speed (e.g., inches per minute), etc.). Experiments were carried out to determine an example bridging limit using GCT 4000 PSI medium set structural mortar mix as matrix material, which is manufactured by Gulf Concrete Technology.

The discussion below summarizes the fresh properties measurements of the example GCT matrix material. The main property characterizations include the Bingham curves, dynamic yield stress, and plastic viscosity. The influence of resting time on static yield stress and plastic viscosity was investigated. The flowability and buildability of the GCT matrix material was carried out at different resting times. Notably, the following tests, measurements, and data represent example embodiments and, given the benefit of this disclosure, one of ordinary skill in the art will appreciate the variations and adaptations available that are consistent with the teachings herein.

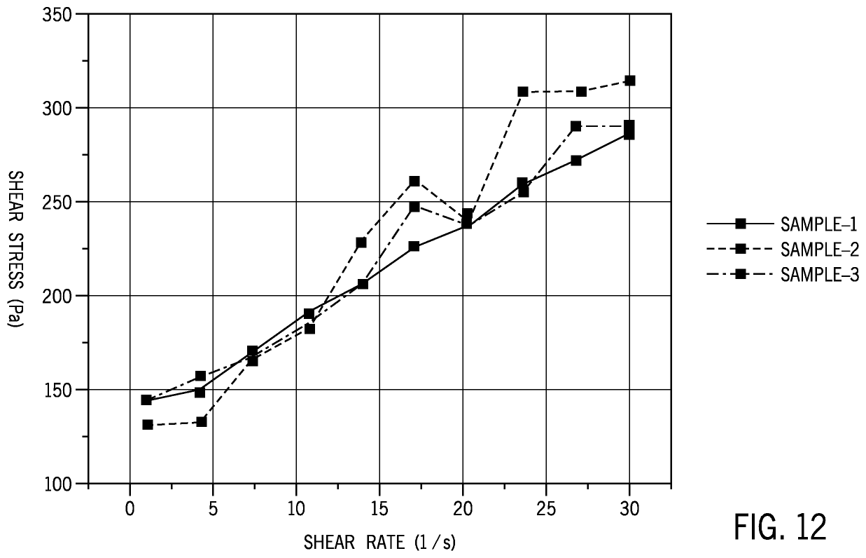

Brigham Model. The rheology of the GCT matrix material was characterized using a Discovery Hybrid Rheometer HR-3, with two-blade vane (radius=22.5 mm) geometry. The testing material cell had a radius of 29 millimeters and a gap of 6.5 millimeters, which is approximately 6.5 times of the maximum particle size of sand used in the GCT matrix material (i.e., approximately 1 millimeter). The Bingham curves measurements are shown in FIG. 12 and Table 1, below. The average dynamic yield stress and average plastic viscosity of the GCT matrix material was found to be about 134.041 Pa and 5.701. Pas, respectively.

TABLE 1

| | Dynamic yield | Plastic viscosity |
|---|---|---|
| Sample No. | stress (Pa) | (Pa · s) |
| Sample-1 | 139.816 | 4.964 |
| Sample-2 | 134.397 | 5.429 |
| Sample-3 | 127.910 | 6.733 |
| Average | 134.041 | 5.701 |
| Std. Dev. | 4.86 | 0.749 |

Time-varying measurement of static yield stress and plastic viscosity. Static yield stress contributes to the buildability of an extruded matrix material (i.e., the ability of a matrix material to form structures). Some matrix materials (e.g., concrete) are time-dependent materials, whose static yield stress increases with the concrete age at the fresh state. The increase of static yield stress over time is due to the flocculation process of the cement particles, nucleation, and formation of calcium silicate hydrate during the cement hydration. In this study, the time-varying behavior of static yield stress and viscosity are measured, respectively.

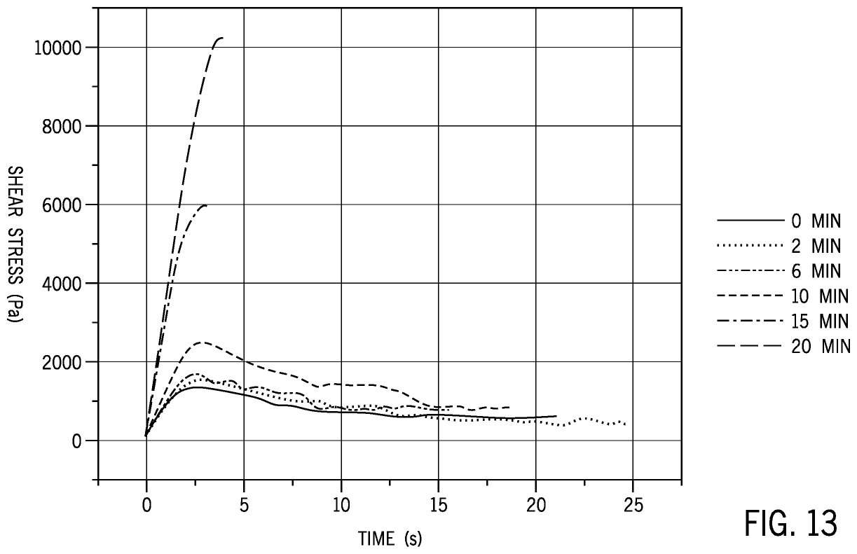

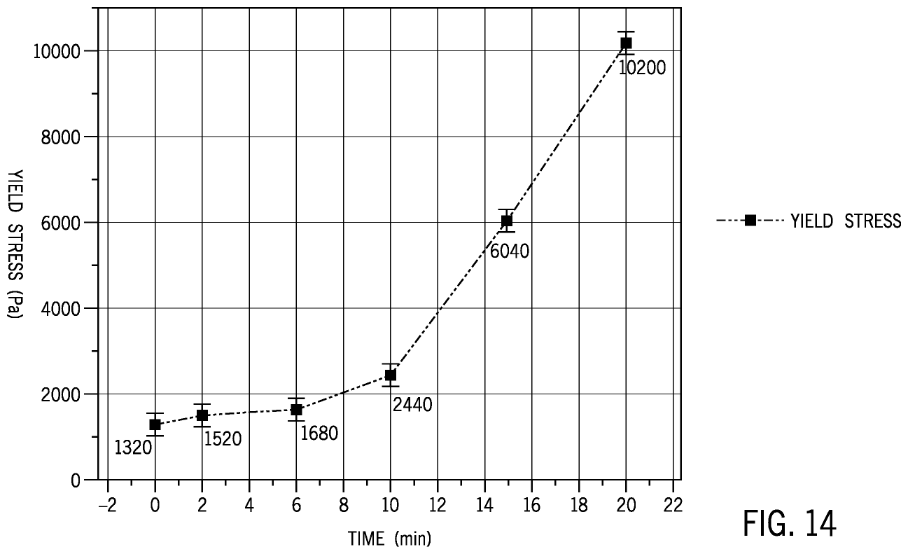

For example, the measurement of static yield stress for the GCT matrix material was performed by using a Brookfield rheometer as follows: firstly, the concrete sample is prepared by the applicable mix procedures; then 500 milliliter of sample is poured into a 1000 milliliter beaker, and the specimen is sheared with a 10 millimeter by 20 millimeter van spindle. The measurement of static yield is carried out at a constant, low fixed shearing speed, 0.2 l/second (i.e., the vane performs 0.2 complete rotations per second, or a single, complete rotation in 5 seconds). The time-varying behavior of static yield stress is determined by conducting a rheology test at the following resting times: 0 minutes, 2 minutes, 6 minutes, 10 minutes, 15 minutes, and 20 minutes. The measured shear-stress curves are shown in FIG. 13 and the measured time-varying static yield stress curve is shown in FIG. 14.

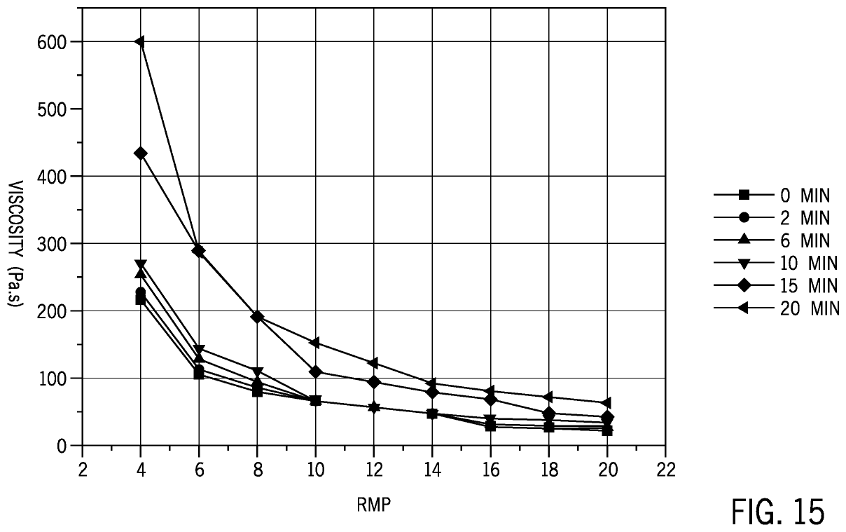

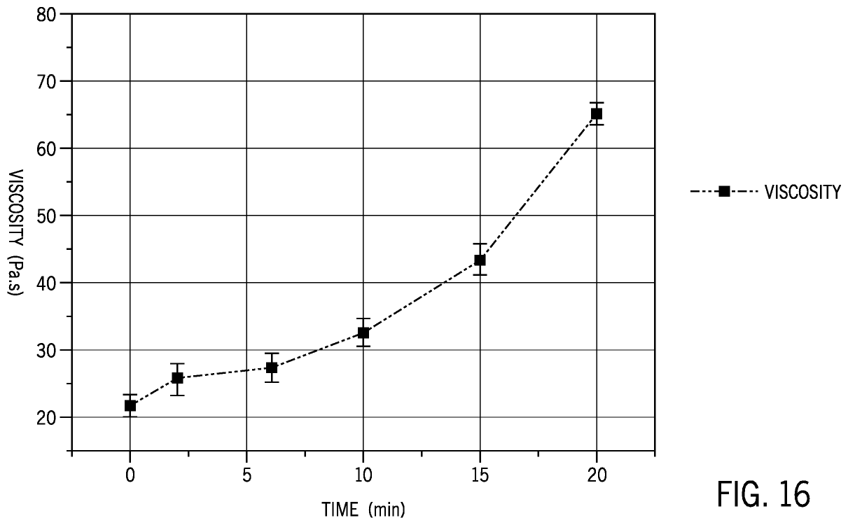

Additionally, the influence of resting time on plastic viscosity was investigated. The plastic viscosity at the resting time was also measured at 0 minutes, 2 minutes, 6 minutes, 10 minutes, 15 minutes, and 20 minutes, according to a ramp testing protocol. The curves of the measured viscosity versus the rheometer spindle speed in revolutions per minute (RPM) are shown in FIG. 15 and the measured time-varying viscosity curve is shown in FIG. 16.

Data from the static yield stress and plastic viscosity stress tests is summarized in Table 2, below.

TABLE 2

| Resting Time | | Static yield | Plastic |
|---|---|---|---|
| (minutes) | | stress (Pa) | viscosity (Pa · s) |
| 0 | Avg. | 1320 | 21.72 |
| | Std. Dev. | 224 | 1.56 |
| 2 | Avg. | 1520 | 25.64 |
| | Std. Dev. | 233 | 2.35 |
| 6 | Avg. | 1680 | 27.34 |
| | Std. Dev. | 253 | 2.15 |
| 10 | Avg. | 2440 | 32.58 |
| | Std. Dev. | 231 | 2.04 |
| 15 | Avg. | 6040 | 43.44 |
| | Std. Dev. | 192 | 2.42 |
| 20 | Avg. | 10200 | 65.16 |
| | Std. Dev. | 219 | 1.5 |

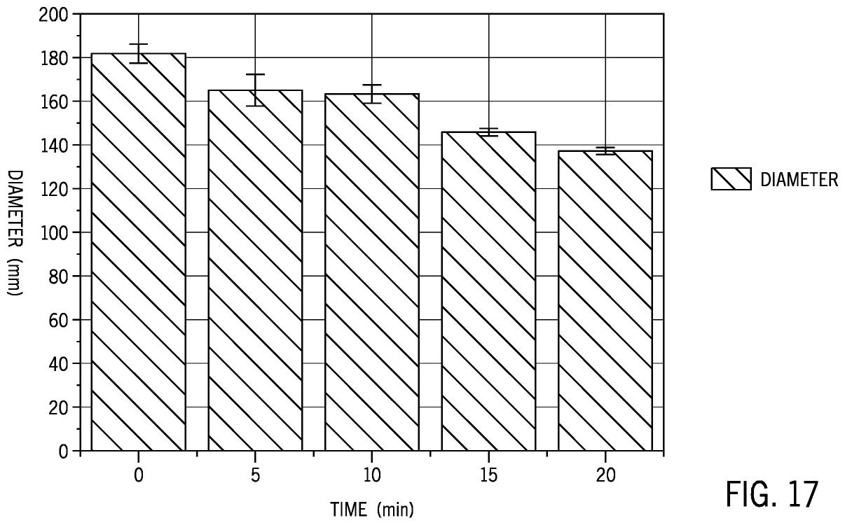

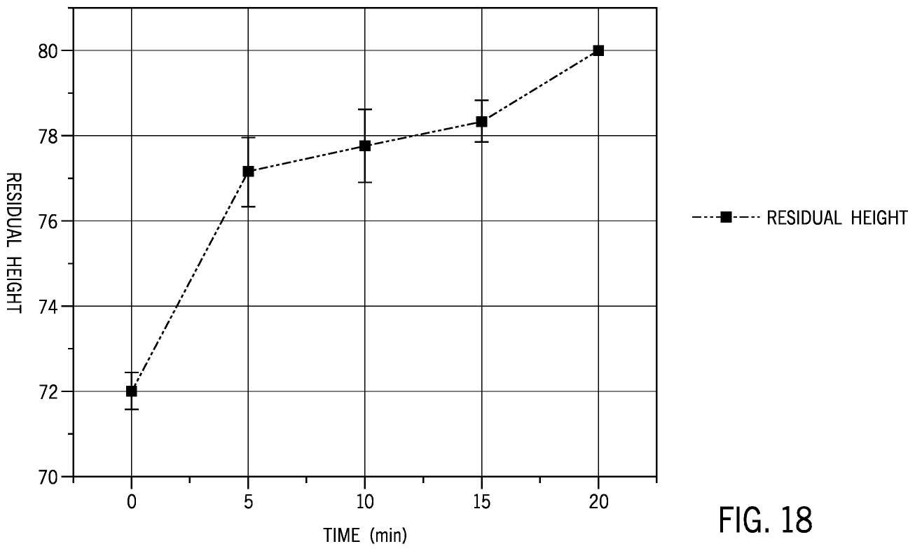

Flowability and Buildability. The flowability of the GCT matrix material versus resting time was also investigated. To test flowability, a flow table test was carried out according to the ASTM C230 test procedure, in which freshly extruded GCT matrix material was poured into a hollow, conical mold with a height of 50 millimeters, a top diameter of 70 millimeters, and a bottom opening diameter of 100 millimeters. The bottom opening was in contact with the flow table and the conical mold was filled with three layers of extruded GCT matrix material through the top opening. Each layer of GCT matrix material was compacted by rodding fifteen times, prior to adding any subsequent layer (e.g., by tamping each layer with fifteen strokes of the rounded end of the tamping rod in a uniform manner over the cross-section of the mold). Where a previous layer was already provided (e.g., as was the case for the second and third layers) the rod also penetrated each of the previous layers. The GCT matrix material was them allowed to rest for a predetermined resting time prior to the cylinder being removed to allow the GCT matrix material to flow outwardly on a support surface. Once the cylinder was removed, the diameter and residual height of the GCT matrix material was measured. As shown in FIG. 17, diameters were measured for resting times of 0 minutes, 5 minutes, 10 minutes, 15 minutes, and 20 minutes. Higher resting time resulted in reduced flowability (i.e., smaller final diameters). Likewise, as shown in FIG. 18, residual heights were measured at the same resting times, with higher resting times resulting in increased residual heights. Test results for flowability and buildability are also shown in Table 3, below.

TABLE 3

| Resting Time | | Flowability | Buildability |
|---|---|---|---|
| (minutes) | | (mm) | (mm) |
| 0 | Avg. | 181.001 | 72.050 |
| | Std. Dev. | 0.790 | 0.433 |
| 5 | Avg. | 164.75 | 77.175 |
| | Std. Dev. | 5.804 | 0.804 |
| 10 | Avg. | 163.501 | 77.800 |
| | Std. Dev. | 3.500 | 0.878 |
| 15 | Avg. | 145.075 | 78.375 |
| | Std. Dev. | 2.104 | 0.496 |
| 20 | Avg. | 136.75 | 80.000 |
| | Std. Dev. | 1.785 | 0.000 |

Strength. The strength of the GCT matrix material over time was also investigated. Specifically, as shown in Table 4, below, samples of GCT matrix material were tested to determine compressive strength, Young's Modulus, and the Modulus of Rupture at various resting times.

TABLE 4

| | | Compressive | Young's | Modulus of |
|---|---|---|---|---|
| Resting Time | | Strength (kPa) | Modulus (kPa) | Rupture (kPa) |
| 5 | minutes | 4.14 | 62.6 | — |
| 30 | minutes | 174.44 | 3871 | 267 |
| 2 | hours | 5689 | — | — |
| 10 | hours | — | 58212 | — |
| 28 | days | 14617 (printed) | — | — |
| | | 25338 (cast) | | |

Bridging Limit. The bridging limit of the example GCT matrix material was also tested across two types of elongate strands, namely a first braided steel cable with a diameter of ⅛ inches and second braided steel cable with a diameter of 3/32 inches, as well as between flat surfaces. The tests were carried out using deposition heights of approximately 15 millimeters and approximately 25 millimeters. All other operational parameters were held constant, including an extruder speed of 100 millimeters/second, a circular nozzle shape with a diameter of 25.4 millimeters, and an extrusion rate of approximately 2 liters/minute. As shown in summarized test results in Table 5, the maximum bridging distance was approximately 80 millimeters for the flat surfaces and 40 millimeters for both the elongate strands, all of which were achieved with a deposition height of 25 millimeters.

TABLE 5

Bridging Limit (mm)

| | 15 mm | 25 mm |
|---|---|---|
| | Deposition | Deposition |
| Support Structure | Height | Height |
| ⅛ inch Braided Steel | 0 | 40 |
| Cable | | |
| 3/32 inch Braided | 0 | 40 |
| Steel Cable | | |
| Flat Platform | 0 | 80 |

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

In some non-limiting examples, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, non-limiting examples of the invention can be implemented as a set of instructions, tangibly embodied on a non-transitory computer-readable media, such that a processor device can implement the instructions based upon reading the instructions from the computer-readable media. Some non-limiting examples of the invention can include (or utilize) a control device such as an automation device, a special purpose or general purpose computer including various computer hardware, software, firmware, and so on, consistent with the discussion herein. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some non-limiting examples, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIG., or otherwise disclosed herein, can be executed in different orders than are expressly illustrated or described, as appropriate for particular non-limiting examples of the invention. Further, in some non-limiting examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

I/We claim:

1. A method of manufacturing a structure, the method comprising:
securing, using an automated extruder, a reinforcing structure to a base structure, the base structure defining a first support portion and a second support portion, the reinforcing structure being secured to each of the first support portion and the second support portion to define an unsupported area between the first support portion and the second support portion; and
extruding, using the automated extruder, a first layer of a matrix material onto the unsupported area of the reinforcing structure.

2. The method of claim 1, further including allowing the matrix material to solidify to form a slab that is supported along a first edge by the first support portion and along a second edge by the second support portion, the slab being unsupported between the first support portion and the second support portion.

3. The method of claim 1, further comprising:
extruding, using the automated extruder, a second layer of the matrix material onto the first layer, the second layer substantially covering the first layer.

4. The method of claim 3, wherein the first layer is formed by extruding a first series of parallel beads at a first angle and the second layer is formed by extruding a second series of parallel beads at a second angle.

5. The method of claim 4, wherein the first angle is orthogonal to the second angle.

6. The method of claim 1, wherein the reinforcing structure is a mesh formed from one more elongate strands.

7. The method of claim 6, wherein the one or more elongate strands are sections of a single continuous strand.

8. The method of claim 6, wherein the one or more elongate strands are secured at a predetermined tension.

9. The method of claim 6, wherein securing the reinforcing structure to the base structure includes:
coupling a first plurality of anchors to the first support portion of the base structure, and a second plurality of anchors to the second support portion of the base structure; and
securing the one or more elongate strands to extend between at least one of the first plurality of anchors and at least one of the second plurality of anchors.

10. The method of claim 6, wherein securing the reinforcing structure to the base structure includes:
coupling a first brace to the first support portion of the base structure, the first brace including a stationary member that is fixedly secured to the base structure and a movable member configured to move relative to the stationary member;
coupling a second brace to the second support portion the base structure;
securing the one or more elongate strands to extend between the movable member of the first brace and the second brace; and
moving the movable member relative to the stationary member to apply a tension to the one or more elongate strands.

11. The method of claim 6, wherein the mesh defines a gap distance that is less than a bridging limit of the matrix material.

12. The method of claim 1, wherein the matrix material is a cementitious material.

13. The method of claim 1, wherein the base structure is formed by extruding the matrix material using the automated extruder.

14. A method of manufacturing a structure, the method comprising:
securing, using an automated extruder, a reinforcing structure to a base structure, the reinforcing structure being secured to and supported by the base structure at least partially along a perimeter of the reinforcing structure and being unsupported within a central area of the reinforcing structure; and
extruding, using the automated extruder, a matrix material onto the central area of the reinforcing structure.

15. The method of claim 14, further comprising:
allowing the matrix material to solidify to form a slab with the reinforcing structure, the slab being secured to and supported by the base structure along a perimeter of the slab and being unsupported at the central area of the slab.
